(19) United States
(12) Patent Application Publication
(10) Pub. No.: US 2025/0040532 A1
(43) Pub. Date: Feb. 6, 2025

(54) INSECT TRAP AND INSECT TRAP HOLDER

(71) Applicant: twopoint0 LLC, Richmond, VA (US)

(72) Inventor: Martin Maggio, Dubai Marina (AE)

(21) Appl. No.: 18/365,114

(22) Filed: Aug. 3, 2023

(51) Int. Cl. A01M 1/14; A01M 1/02

(52) U.S. Cl. CPC A01M 1/145; A01M 1/02

(57) ABSTRACT

Examples of the present disclosure include an insect trap. The insect trap includes: a container configured to receive a liquid, an adhesive material, and a holder. The holder includes an electrical plug. The electrical plug includes a first end configured to be received by an electrical socket and a second end opposite the first end. The holder includes a surface configured to receive the adhesive material. The holder includes a pocket configured to removably receive the container. The pocket includes an edge positioned a distance away from the second end of the electrical plug in a first direction substantially parallel to the electrical plug.

### FIELD

This disclosure relates generally to systems and apparatuses for trapping insects, and more particularly to insect traps and plug-in insect trap holders.

### BACKGROUND

Insects can be a problem within indoor environments, posing concerns for human health, comfort, and property. Insect traps are designed to attract, capture, remove and/or eliminate insects. Insect traps target insect species commonly found in households, including but not limited to flies, mosquitoes, ants, cockroaches, and moths.

### SUMMARY

The subject matter of the present application has been developed in response to the present state of the art, and in particular, in response to the shortcomings of insect traps that have not yet been fully solved by currently available techniques. Accordingly, the subject matter of the present application has been developed to provide insect traps and insect trap holders that overcome at least some of the above-discussed shortcomings of prior art techniques.

The following is a non-exhaustive list of examples, which may or may not be claimed, of the subject matter, disclosed herein.

The following portion of this paragraph delineates example 1 of the subject matter, disclosed herein. According to example 1, an insect trap includes: a container configured to receive a liquid, an adhesive material, and a holder. The holder includes an electrical plug. The electrical plug includes a first end configured to be received by an electrical socket and a second end opposite the first end. The holder includes a surface configured to receive the adhesive material. The holder includes a pocket configured to removably receive the container. The pocket includes an edge positioned a distance away from the second end of the electrical plug in a first direction substantially parallel to the electrical plug.

The following portion of this paragraph delineates example 2 of the subject matter, disclosed herein. According to example 2, which encompasses example 1, above, the distance is equal to or greater than one fifth of a distance between the second end of the electrical plug and an end of the holder.

The following portion of this paragraph delineates example 3 of the subject matter, disclosed herein. According to example 3, which encompasses example 1 or 2, above, the insect trap includes a lid removably coupled to the container. The lid includes a number of openings. The number of openings include a first opening having a first area and a second opening having a second area greater than the first area.

The following portion of this paragraph delineates example 4 of the subject matter, disclosed herein. According to example 4, which encompasses any one of examples 1-3, above, the container is configured to be removably received by the pocket while the lid is attached to the container.

The following portion of this paragraph delineates example 5 of the subject matter, disclosed herein. According to example 5, which encompasses any one of examples 1-4, above, the first area and the second area are equal to or greater than 0.5 square centimeters.

The following portion of this paragraph delineates example 6 of the subject matter, disclosed herein. According to example 6, which encompasses any one of examples 1-5, above, the holder includes a body rotatable with respect to the electrical plug about an axis substantially parallel to the first direction. The surface is a surface of the body.

The following portion of this paragraph delineates example 7 of the subject matter, disclosed herein. According to example 7, which encompasses any one of examples 1-6, above, the surface of the holder faces the electrical plug. The holder includes a second surface opposite the first surface and is configured to removably receive the cover.

The following portion of this paragraph delineates example 8 of the subject matter, disclosed herein. According to example 8, which encompasses any one of examples 1-7, above, the first surface faces the pocket and extends in a second direction substantially perpendicular to the first direction.

The following portion of this paragraph delineates example 9 of the subject matter, disclosed herein. According to example 9, which encompasses any one of examples 1-8, above, the insect trap includes a number of tabs positioned on a number of edges of the pocket. The tabs are configured to release the container from the pocket.

The following portion of this paragraph delineates example 10 of the subject matter, disclosed herein. According to example 10, which encompasses any one of examples 1-9, above, the insect trap includes a panel to which the adhesive material is removably attached.

The following portion of this paragraph delineates example 11 of the subject matter, disclosed herein. According to example 11, which encompasses any one of examples 1-10, above, the surface includes at least two protrusions configured to removably receive the panel.

The following portion of this paragraph delineates example 12 of the subject matter, disclosed herein. According to example 12, which encompasses any one of examples 1-11, above, the liquid includes a scented insect attractant.

The following portion of this paragraph delineates example 13 of the subject matter, disclosed herein. According to example 13, which encompasses any one of examples 1-12, above, the holder includes a third surface substantially perpendicular to the first surface. The pocket is positioned on the third surface.

The following portion of this paragraph delineates example 14 of the subject matter, disclosed herein. According to example 14, which encompasses any one of examples 1-13, above, the insect trap includes a number of light sources positioned on the third surface and electrically coupled to the electrical plug.

The following portion of this paragraph delineates example 15 of the subject matter, disclosed herein. According to example 15, which encompasses any one of examples 1-14, above, at least one light source of the number of light sources is configured to emit light having a wavelength of not less than 300 nanometers (“nm”) and not greater than 570 nm.

The following portion of this paragraph delineates example 16 of the subject matter, disclosed herein. According to example 16, which encompasses any one of examples 1-15, above, the insect trap includes an elongated member through which the electrical plug is coupled to the holder.

The following portion of this paragraph delineates example 17 of the subject matter, disclosed herein. According to example 17, which encompasses any one of examples 1-16, above, the pocket is positioned so that the pocket is below a top end of the adhesive material when the surface receives the adhesive material.

The following portion of this paragraph delineates example 18 of the subject matter, disclosed herein. According to example 18, which encompasses any one of examples 1-17, above, a depth of the pocket is less than a depth of the container.

The following portion of this paragraph delineates example 19 of the subject matter, disclosed herein. According to example 19, a holder for an insect-trapping container includes an electrical plug. The electrical plug includes a first end configured to be received by an electrical socket. The first end includes a first end of the holder. The electrical plug includes a second end opposite the first end. The holder includes a body coupled to and rotatable with respect to the electrical plug. The body includes a first surface extending in a first direction. The first surface faces the electrical plug. The first surface includes at least two protrusions configured to removably receive a panel. The body includes a second surface opposite the first surface and extending in the first direction. The second surface is configured to removably receive a cover. The body includes a third surface extending in a second direction substantially perpendicular to the first direction. The third surface includes a pocket. The pocket is configured to receive a container. The pocket includes an edge positioned a distance, in the second direction, away from the second end of the electrical plug. The distance is equal to or greater than one fifth of a distance, in the second direction, between the second end of the electrical plug and a second end of the holder opposite to the first end of the holder. The third surface includes a number of light sources electrically coupled to the electrical plug. At least one light of the number of lights emits light having a wavelength of not less than 300 nanometers (“nm”) and not greater than 570 nm. The insect-trapping holder includes a number of tabs coupled to at least one of the third surface and the pocket and configured to release the container from the pocket.

The following portion of this paragraph delineates example 20 of the subject matter, disclosed herein. According to example 20, the first surface faces the pocket.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a front view of an insect trap holder plugged into a wall, according to one or more examples of the present disclosure;

FIG. 2A is a perspective view of an assembled insect trap, according to one or more examples of the present disclosure;

FIG. 2B is a side view of an assembled insect trap, according to one or more examples of the present disclosure;

FIG. 3 is a back perspective view of an insect trap holder, according to one or more examples of the present disclosure; and

FIG. 4 is a side view of an insect trap and insect trap holder plugged into a wall and without a cover, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

A plug-in insect trap can help to reduce the presence of insects within indoor environments. Examples of the present disclosure include insect traps 100 with multiple mechanisms for attracting and entrapping insects that are not necessarily limited to one type of insect. Examples of the present disclosure also include insect traps 100 with components to help facilitate integration of the trap 100 into an indoor environment. For example, some insect traps 100 of the present disclosure include components to help enable both physical and aesthetic integration of an insect trap 100 with a wall 150 of an indoor environment.

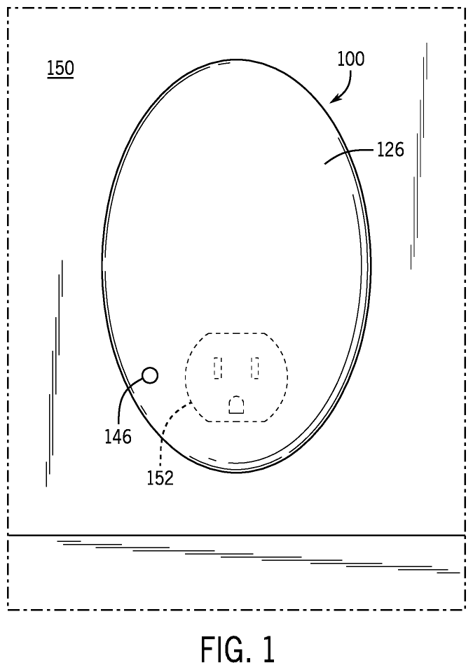

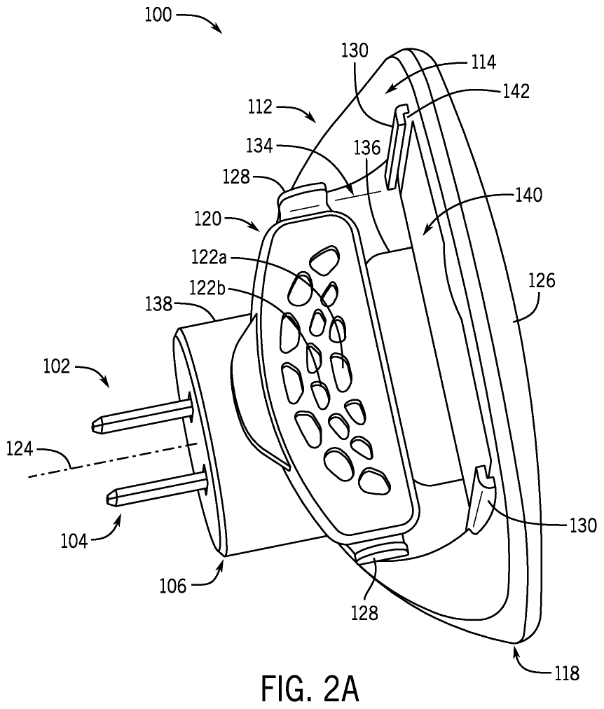

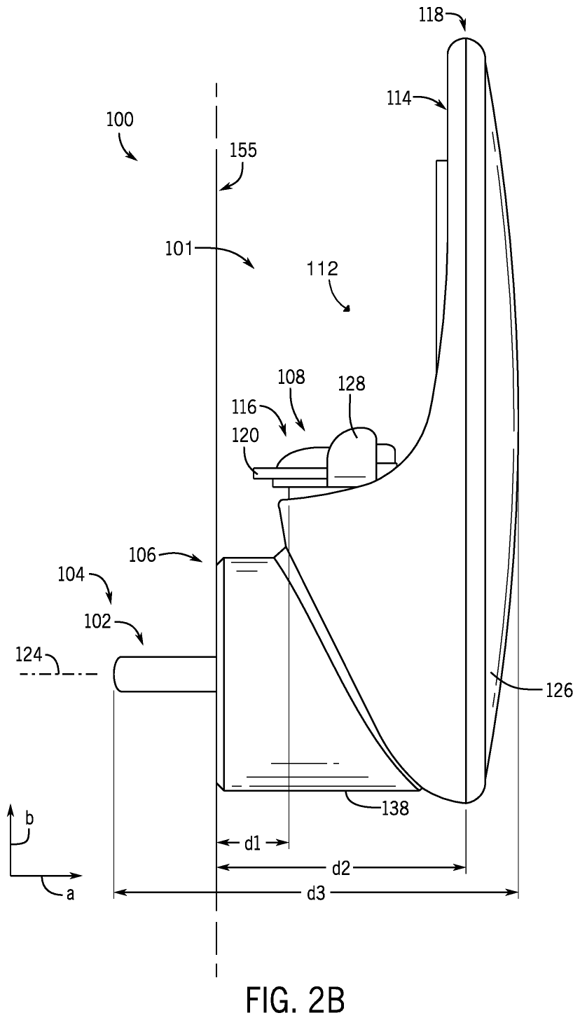

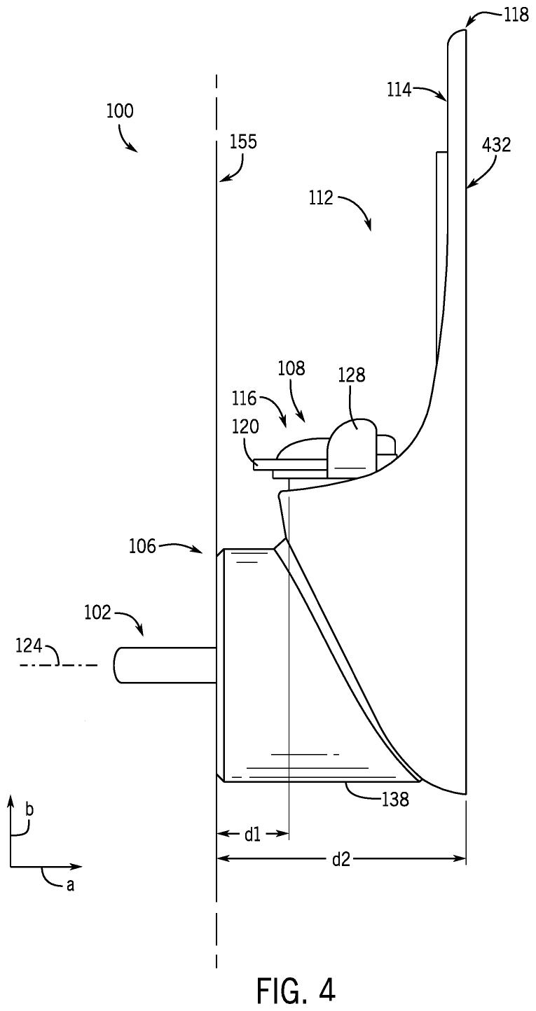

FIG. 1 is a front view of an insect trap 100 plugged into a wall 150 via an electrical socket 152, according to one or more examples of the present disclosure. As shown in FIG. 1, the insect trap 100 includes a removable cover 126. In some examples, the removable cover 126 aids in visual integration of the trap 100 with the wall 150. For example, the removable cover is of a shade and/or texture that is close to a shade and/or texture of the wall 150 of the electrical socket 152. For example, the wall 150 is painted white, and the cover 126 is also white. The cover 126 is also removable from a body 112 of the insect trap 100, as shown in FIG. 4, to be exchanged for another cover that better matches the appearance of the wall 150. FIG. 2B is a side view of the system 100 with the cover 126 attached.

As shown in FIG. 1, the insect trap 100 is received by an electrical socket 152 of the wall 150. Through an electrical connection between the insect trap 100 and the electrical socket 152 (e.g., the electrical plug 102 shown in FIG. 2A), various components of the insect trap 100 receive current. For example, the insect trap 100 includes a power-indicating light-emitting diode (“LED”) 146 that is illuminated and visible, even though the cover 126 of the insect trap holder 100, to indicate that the insect trap 100 is electrically connected to the electrical socket 152.

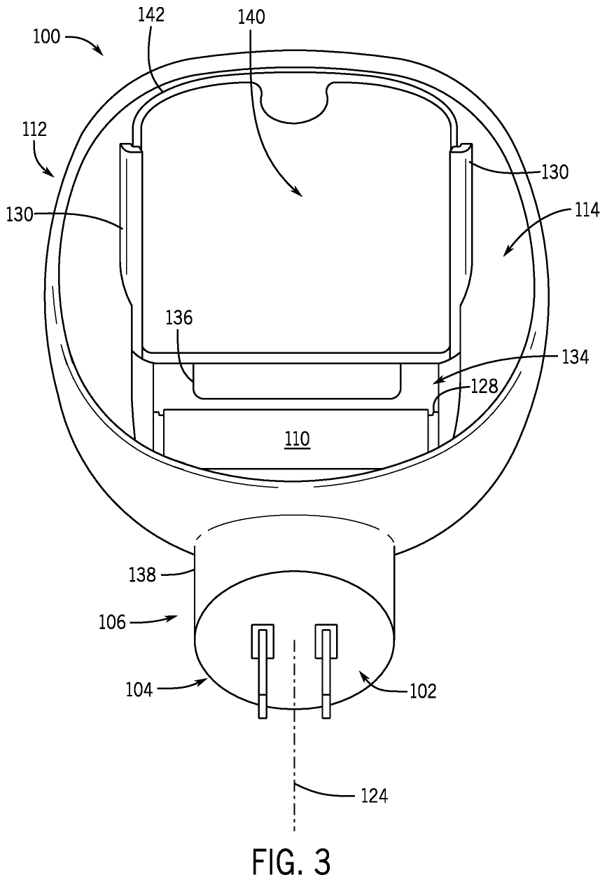

FIG. 2A is a perspective view of an assembled insect trap 100. As shown in FIG. 2A, the insect trap 100 includes a holder 101 and a container 108. The holder 101 is configured to receive the container 108. For example, as shown in FIG. 3, the insect trap holder 101 includes a pocket 110 configured to receive the container 108.

The container 108 is configured to hold a luring material 160, such as a scented insect attractant. In some examples, the liquid 160 is a scented liquid. For example, the liquid emits a scent likely to attract insects. In some examples, the liquid 160 includes one or more organic compounds. For example, the liquid 160 includes an organic compound that attracts insects but is not toxic and thus does not pose a threat to accidental consumers, such as children or pets. Examples of the present disclosure are not limited to a liquid. In some examples, the luring material 160 is a solid and/or gaseous material. In some examples, the luring material 160 includes a pheromone-impregnated luring agent, such as a luring agent that includes a synthetic sex pheromone designed for insect attraction.

The lid 120 is configured to be removably attached to the container 108. As shown in FIG. 2A, the lid 120 includes a number of openings 122. The openings 122 are configured to receive insects. In some examples, the number of openings 122 include a first opening 122a having a first area and a second opening 122b having a second area greater than the first opening 122a. For example, as shown in FIG. 2A, the lid 120 includes a number of smaller openings 122a that are configured to receive insects. The lid 120 also includes a larger opening 122b that is large enough to not only receive insects but also through which to receive liquid 160 into the container 108 without removing the lid 108.

Each of the openings 122 have an area equal to or greater than 0.5 square centimeters (“cm”) such that insects, such as fruit flies, may pass through the openings 122 and become entrapped in the container 108 by the luring material 160. For example, the insects are attracted to the container 108 due to scents emitted from the liquid. The insects thus travel through at least openings 122a. The insects then enter the luring material 160, which is a scented liquid that drowns the insects. Although not shown in FIG. 2A, in some examples, the container 108 includes one or more angled sides. In some examples, the bottom of the container 108 is angled with respect to the first direction a.

In some examples, each of the lid 120 and the container 108 are made of a plastic material. The lid 120 is made of a flexible plastic material to facilitate removal from the container 108. For example, the lid 120 is made of thermoplastic polyurethane. In some examples, the lid 120 is of a color likely to attract flying insects. For example, the lid 120 includes material of colors reflecting light at a wavelength of less than 580 nanometer (“nm”). The lid 120, for example, includes material of the following colors: blue, violet, purple, and/or cyan.

FIG. 3 is a back perspective view of an insect trap 100 having an insect trap holder 101, according to one or more examples of the present disclosure. As shown in FIG. 3, the insect trap 100 includes a container 108, an adhesive material 140, and a holder 101. The holder 101 is configured to receive the container 108 and the adhesive material 140.

The holder 101 includes the electrical plug 102. The electrical plug 102 includes a first end 104 configured to be received first by an electrical socket 152 of a wall 150. The electrical plug 102 also includes a second end 106 the is opposite to the first end 104. Although FIGS. 1-5 show an electrical plug 102 and socket 152 of Type A, examples of the present disclosure are not so limited. Examples of the present disclosure include electrical plugs 102 configured to be physically received by and receive current from sockets 152 of any type. Examples of the present disclosure include plugs 102 of Types A-M.

Referring to FIG. 2B, in some examples, the insect trap 100 includes an elongated member 138 through which the plug 102 is coupled to the holder 101. This elongated member 138 helps to create additional distance d1 between an edge 116 of the pocket and container 108 and the electrical plug 102. Maintaining the distance d1 helps to prevent accidental spillage of the luring material 160—which, in some examples, includes a liquid-onto the electrical plug 102. The elongated member 138 also helps to facilitate insertion into and removal from the socket 152.

The holder 101 includes a body 112. The body 112 is fixed to the elongated member 138. The body 112 is rotatable with respect to the electrical plug 102 about an axis 124 that is substantially parallel to the first direction a. In some examples, the body 112 is configured to rotate about the axis 124 and can lock into place in a number of positions. For example, the body 112 is rotated approximately 25 degrees about the axis 124. The body 112 remains in that position while plugged into the wall 150, and the trap 110 attracts and entraps insects while the body 112 is in that position. In some examples, the plug 102 is rotatable with respect to the body 112.

The body includes a first surface 114, a second surface 532, and a third surface 134. The first surface 114 is configured to receive the adhesive material 140. The adhesive material faces away from the first surface 114. As such, insects that come into contact with the adhesive material 140 can become entrapped in it. In some examples, the adhesive material 140 is of a color to attract certain insects. For example, the adhesive material 140 is configured to attract mosquitoes, and the color of the material 140, includes, but is not limited to: blue, red, orange, black, or any combination thereof. In some examples, the first surface 114 is of a color attractive to insects, and the adhesive material 140 is transparent.

In some examples, the adhesive material 140 is attached to the first surface 114 directly. For example, the adhesive material 140 is a flexible sheet with a first adhesive side that attaches to the first surface 114. The sheet includes a second adhesive side that faces away from the first surface 114 to attract insects. In some examples, the adhesive material 140 is flexible. To remove the adhesive material 140, the user pulls an edge of the adhesive material 140 to detach it from the first surface 114. In some examples, the adhesive material. 104 is a sheet an adhesive side facing away from the first surface 114 to attract insects and a second side opposite the first side that is not adhesive. In such embodiments, the adhesive material 140 is kept in place by one or more protrusions 130 of the first surface 114.

As shown in FIG. 3, in some examples, the surface 114 is configured to receive a panel 142 of the insect trap 100. The adhesive material 140 is removably attached to the panel 142. For example, the adhesive material 140 is removably attached to the panel 142 in a similar manner as described above in connection with attachment to the first surface 114.

As shown in FIG. 3, in some examples, the first surface 114 includes a number of protrusions 130 configured to receive the panel 142. For example, as shown in FIG. 3, the protrusions 130 extend in a first direction a away from the first surface 114 and in another direction towards each other. As such, the protrusions 130 hold the panel 142 upright and substantially parallel to the first surface 114 while allowing removal of the panel 142. For example, the user pulls the panel in a direction b to remove the panel 142 from the body 112. In some examples, the panel 142 includes a handle at a top end to facilitate pulling the panel 142 up and away from the body 112.

As shown in FIG. 4, the body 112 also includes a pocket 110 configured to removably receive the container 108. In some examples, the body 112 includes a third surface 134 substantially perpendicular to the first surface 114. The third surface 134 extends substantially parallel to the first direction a. However, examples of the present disclosure are not so limited. For example, the third surface 134 extends at an angle to the second direction b. As shown in FIG. 4, in some examples, the pocket 110 is positioned on the third surface 134.

As shown in FIG. 4, in the second direction b, the pocket 110 is positioned below at least a top end 155 of the adhesive material 140 when the first surface 114 receives the adhesive material 140. In some examples, the pocket 110 is positioned to receive insects and/or debris, if any, that fall from the adhesive material 140.

In some examples, a depth h2 of the pocket 110 is less than a depth h1 of the container 108. In such examples, the container 108 is visible from an exterior of the holder 101. In some examples, the pocket depth h2 is not less than one tenth of the total height h3 of the body 112 and not greater than two thirds of the total height h3 of the body 112. In some examples, the pocket depth h2 is not less than 1 centimeter (“cm”) and not greater than 11 cms.

As shown in FIG. 3, in some examples, the insect trap 100 includes a number of light sources 136. The light sources 136 aid in attracting insects to the insect trap 100. The number of light sources 136 are positioned on the third surface 134. For example, the light sources 136 are positioned adjacent to the pocket 110. Although FIG. 4 shows the light source 136 positioned further from the plug 102 than the pocket 110 is from the plug 102, examples of the present disclosure are not so limited. In some examples, the number of light sources 136 are positioned closer to the plug 102 than the pocket 110 is to the plug. Although FIG. 3 illustrates only one light source 136, examples of the present disclosure are not so limited. For example, the insect trap 100 includes more than one light source 136.

The number of light sources 136 are electrically coupled to the plug 102. At least one light source of the number of light sources 136 emits light having a wavelength of not less than 300 nanometers (“nm”) and not greater than 570 nm. For example, the light sources 136 emit ultraviolet light (“UV light”) that is not visible to the human eye but attracts insects. In other examples, the light sources 136 emit UV that is close to or within the visible spectrum. In some examples, the light sources 136 are LEDs, such as blue LEDs. In some examples, each of the number of light sources 136 emit light of the same wavelength or within +10 nm of each other.

The pocket 110 includes an edge 116 that is positioned a distance d1 away from the second end 106 of the electrical plug in a first direction a that is substantially parallel to the electrical plug 102. In some examples, the distance d1 is equal to or greater than one fifth of a distance d2 between the second end 106 of the electrical plug 102 and an end 118 of the holder 101. For example, the distance d2 is not less than 6 cm and not greater than 10 cm. In some examples, the distance d1 is not less than one tenth of the distance d2 and not greater than eight tenths of the distance d2. For example, the distance d1 is not less than 0.6 cm and not greater than 8 cm. This distance d1 is created in part by the elongated member 138.

As shown in FIG. 4, the pocket 110 includes a number of tabs 128 positioned on a number of edges of the pocket 110. The tabs 128 are configured to release the container 108 from the pocket 110. For example, the tabs 128 are somewhat elastic. In a locked position, the tabs 128 secure the container 108 to the pocket 110. A user applies force to the tabs 128, and the tabs release from the container 108. In some examples, the container 108 includes grooves and/or protrusions, and the pocket 110 includes corresponding grooves and/or protrusions that mate with the grooves and/or protrusions of the pocket 110 to guide the container 108 into place within the pocket 110 and to secure the container 108 within the pocket 110. Although not shown in the Figures, in some examples, the container 108 and/or the lid 120 includes a number of grooves that are configured to mate with the protrusions 130 of the first surface 114, and the pocket 110 is positioned sufficiently close to the first surface 114 such that the protrusions 130 guide the container 108 into and out of the pocket 110 and/or secure the container 108 and/or lid 120 within the pocket 110.

FIG. 4 is a side view of an insect trap 100 plugged into a wall 155, according to one or more examples of the present disclosure. As shown in FIG. 4, in some examples, the container 108 is removably received by the pocket 110 while the lid 120 is still attached to the container 108. This is true even if the lid 120 has a wider width and/or longer length than the pocket 110. In some examples, the lid 120 is configured to be removed from the container 108 without removing the container 108 from the pocket 110. For example, as shown in FIG. 3, the lid 120 includes a tab 172 configured to remove the lid 120 from the container 108.

As shown in FIGS. 1 and 2B, in some examples, the insect trap 100 includes a cover 126 that is removably attachable to the body 112 of the holder 101. For example, the cover 126 is removably attached to a second surface 132 of the body 112, and the second surface 132 is opposite the first surface 114. The first surface 114 faces the electrical plug 102 and the pocket 110. As such, the pocket 110, container 108, lid 120 and electrical socket 156 are at least partially concealed from certain points of view. For example, as shown in FIG. 1, the cover 126 is the primarily visible portion of the insect trap 100 from a front view when the insect trap 100 is plugged into the wall 150.

In some examples, the cover 126 is removable. For example, as shown in FIG. 4, the cover 126 is configured to be removed from the second surface 432 of the body 112 of the holder 101.

In some examples, the first surface 114 and the second surface 132 each extend in a direction b that is substantially perpendicular to the first direction a. In such examples, the first surface 114 and the second surface 132 conceal portions of the insect trap 100 from view. For example, the first surface 114 and the second surface 132 conceal the container 108, and pocket 110 from at least a front view. In some examples, the body 112 includes additional surfaces concealing the container 108 and pocket 110 from at least a side view.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. An insect trap comprising:
a container configured to receive a liquid;
an adhesive material; and
a holder, the holder comprising:
an electrical plug comprising:
a first end configured to be received by an electrical socket; and
a second end opposite the first end;
a surface configured to receive the adhesive material; and
a pocket configured to removably receive the container, the pocket comprising an edge positioned a distance away from the second end of the electrical plug in a first direction substantially parallel to the electrical plug.

2. The insect trap of claim 1, wherein the distance is equal to or greater than one fifth of a distance between the second end of the electrical plug and an end of the holder.

3. The insect trap of claim 1, further comprising a lid removably coupled to the container, the lid comprising a number of openings, the number of openings comprising a first opening having a first area and a second opening having a second area greater than the first area.

4. The insect trap of claim 3, wherein the container is configured to be removably received by the pocket while the lid is attached to the container.

5. The insect trap of claim 3, wherein each of the first area and the second area are equal to or greater than 0.5 square centimeters.

6. The insect trap of claim 1, wherein the holder further comprises a body rotatable with respect to the electrical plug about an axis substantially parallel to the first direction and the surface comprises a surface of the body.

7. The insect trap of claim 1, further comprising a cover, wherein:
the surface of the holder faces the electrical plug; and
the holder further comprises a second surface opposite the first surface and configured to removably receive the cover.

8. The insect trap of claim 7, wherein the first surface faces the pocket and extends in a second direction substantially perpendicular to the first direction.

9. The insect trap of claim 1, further comprising a number of tabs positioned on a number of edges of the pocket and configured to release the container from the pocket.

10. The insect trap of claim 1, further comprising a panel to which the adhesive material is removably attached.

11. The insect trap of claim 10, wherein the surface further comprises at least two protrusions configured to removably receive the panel.

12. The insect trap of claim 1, wherein the liquid comprises a scented insect attractant.

13. The insect trap of claim 1, wherein the holder further comprises a third surface substantially perpendicular to the first surface, and the pocket is positioned on the third surface.

14. The insect trap of claim 13, further comprising a number of light sources positioned on the third surface and electrically coupled to the electrical plug.

15. The insect trap of claim 14, wherein at least one light source of the number of light sources is configured to emit light having a wavelength of not less than 300 nanometers (“nm”) and not greater than 570 nm.

16. The insect trap of claim 1, further comprising an elongated member through which the electrical plug is coupled to the holder.

17. The insect trap of claim 1, wherein the pocket is positioned so that the pocket is below a top end of the adhesive material when the surface receives the adhesive material.

18. The insect trap of claim 1, wherein a depth of the pocket is less than a depth of the container.

19. A holder for an insect-trapping container, comprising:
an electrical plug comprising:
a first end configured to be received by an electrical socket, the first end comprising a first end of the holder; and
a second end opposite the first end; and
a body coupled to and rotatable with respect to the electrical plug, the body comprising:
a first surface extending in a first direction, facing the electrical plug, and comprising at least two protrusions configured to removably receive a panel;
a second surface opposite the first surface and extending in the first direction, the second surface configured to removably receive a cover;
a third surface extending in a second direction substantially perpendicular to the first direction, the third surface comprising:
a pocket configured to receive a container, the pocket comprising an edge positioned a distance, in the second direction, away from the second end of the electrical plug, the distance being equal to or greater than one fifth of a distance, in the second direction, between the second end of the electrical plug and a second end of the holder opposite to the first end of the holder;
a number of light sources electrically coupled to the electrical plug, wherein at least one light of the number of lights emits light having a wavelength of not less than 300 nanometers (“nm”) and not greater than 570 nm; and
a number of tabs coupled to at least one of the third surface and the pocket and configured to release the container from the pocket.

20. The insect trap holder of claim 19, wherein the first surface faces the pocket.
